(19) United States
(12) Patent Application Publication
(10) Pub. No.: US 2024/0368199 A1
(43) Pub. Date: Nov. 7, 2024

(54) HYDROSILYLATION PROCESS CATALYSED BY A COBALT COMPLEX

(71) Applicants: ELKEM SILICONES FRANCE SAS, Lyon (FR); CPE LYON, Villeurbanne (FR); CENTRE NATIONAL DE LA RECHERCHE SCIENTIFIQUE, Paris (FR); UNIVERSITE CLAUDE BERNARD LYON 1, Villeurbanne (FR)

(72) Inventors: James DELORME, Villeurbanne (FR); Raphaeal MIRGALET, Lyon (FR); Delphine BLANC, Lyon (FR); Vincent MONTEIL, Lyon (FR); Jean RAYNAUD, Villeurbanne (FR); Magali PUILLET, Lyon (FR)

(21) Appl. No.: 18/686,974

(22) PCT Filed: Aug. 30, 2022
(86) PCT No.: PCT/FR2022/000077

§ 371 Date: Feb. 27, 2024

(30) Foreign Application Priority Data
Aug. 31, 2021 (FR) FR2109057

(51) Int. Cl. C07F 7/08; B01J 31/18; B01J 37/03; C07F 9/58; C07F 15/06

(52) U.S. Cl. CPC C07F 7/0829; B01J 31/1805; B01J 31/189; B01J 37/031; C07F 9/58; C07F 15/065; B01J 2231/323; B01J 2531/004; B01J 2531/0213; B01J 2531/0238; B01J 2531/845

(57) ABSTRACT

The present invention relates to a process for hydrosilylating an unsaturated compound with a compound comprising at least one hydrogenosilyl function catalysed by organic cobalt compounds in the presence of a compound (E) having the formula (3): R′—OH (3), wherein R′ represents the hydrogen atom or R′ is chosen from the group consisting of alkyl groups having 1 to 8 carbon atoms, cycloalkyl groups having 6 to 12 carbon atoms, aryl groups having 6 to 12 carbon atoms, aryl-alkyl groups, and silyl groups.

### TECHNICAL FIELD

The present invention relates to hydrosilylation reactions between an alkene or alkyne compound and compound comprising at least one hydrogen bonded to a silicon atom. More specifically, the invention relates to the use of a new type of catalyst for these reactions. These catalysts in particular enable silicone compositions to be cured by crosslinking.

### PRIOR ART

During a hydrosilylation reaction (also referred to as a polyaddition reaction), an unsaturated compound, i.e. a compound comprising at least one double bond or triple bond unsaturation reacts with a compound comprising at least one hydrosilyl function, i.e. a hydrogen atom bonded to a silicon atom. This reaction may for example be described in the case of an alkene unsaturation by:

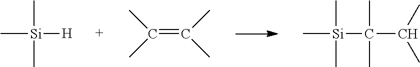

or else in the case of an alkylne insaturation by:

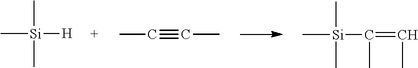

The hydrosilylation reaction may be accompanied by, or even sometimes be replaced by, a dehydrogenative silylation reaction. The reaction may be described by:

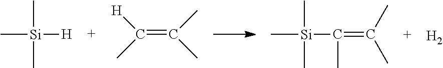

The hydrosilylation reaction is notably used for crosslinking silicone compositions comprising organopolysiloxanes bearing alkenyl or alkynyl units and organopolysiloxanes comprising hydrosilyl functions.

The reaction for hydrosilylation of unsaturated compounds is typically carried out by catalysis, using metallic or organometallic catalysts. Currently, the catalyst suitable for this reaction is a platinum catalyst. Thus, most industrial hydrosilylation processes, in particular for the hydrosilylation of alkenes, are catalysed by Speier's hexachloroplatinic acid or by Kartstedt's Pt (0) complex of general formula Pt₂ (divinyltetramethyldisiloxane)₃ (or Pt₂ (DVTMS)₃ in abbreviated form).

At the start of the 2000s, the preparation of platinum-carbene complexes made it possible to access more stable catalysts (see, for example, patent application WO 01/42258).

However, the use of metallic or organometallic catalysts containing platinum is still problematic. It is an expensive metal which is becoming increasingly scarce and the cost of which fluctuates enormously. The industrial scale use thereof is therefore difficult. It is thus desired to minimize the amount of catalyst needed for the reaction, without however reducing the yield and the rate of the reaction. Many studies have been carried out to find alternatives to Karstedt's catalyst.

In this context, studies have been carried out for years to find new catalysts for carrying out the hydrosilylation of alkenes.

In international patent application WO 2018/115601, the use of new cobalt-based catalysts as hydrosilylation and/or dehydrogenative silylation catalysts was described. These new catalysts are described by the general formula [Co(N(SiR₃)₂)^{x}]_{y} wherein the R symbols, which may be identical or different, represent a hydrogen atom or a hydrocarbon radical having from 1 to 12 carbon atoms, x is equal to 1, 2 or 3 and y is equal to 1 or 2. The inventors have demonstrated that these new catalysts could effectively catalyse hydrosilylation and/or dehydrogenative silylation reactions, advantageously without solvents since they have a good solubility in the silicone oils. However, these compounds were prepared and handled in the absence of air and water. The hydrosilylation and/or dehydrogenative silylation process is carried out under an inert atmosphere in a glove box. The examples were all performed under an inert atmosphere, in a glove box and/or in a sealed pill box.

Similarly, cobalt catalysts were described in the scientific publication by Yang Liu and Liang Deng, “Mode of Activation of Cobalt (II) Amides for Catalytic Hydrosilylation of Alkenes with Tertiary Silanes” (J. Am. Chem. Soc. 2017, 139, 1798-180). The reactions were performed under strict anhydrous conditions, under an inert atmosphere of dry nitrogen, notably in a glove box. The solvents were dried and degassed before use (see same publication, Supporting Information).

There is therefore a technical preconception according to which the catalyst described in the prior art must be produced, stored and used under anhydrous conditions, in the absence of air and water. Furthermore, the other reagents and any solvents must be dried before use. From an industrial point of view, it is difficult and expensive to comply with such conditions.

Furthermore, other documents describing hydrosilylation catalyst may be mentioned. International patent application WO 2016/099727 describes hydrosilylation catalysts based on iron, cobalt, manganese, nickel or ruthenium which are characterized by the use of a specific ligand of formula R¹₂P—X—N═C(R²)—Y. International patent application WO 2005/028544 describes a heterogeneous catalytic composition comprising at least one metal chosen from cobalt, rhodium, ruthenium, platinum and nickel and which is deposited on an inert support, characterized in that the hydrosilylation is carried out in the presence of at least one inorganic non-nucleophilic base and optionally water.

### SUMMARY OF THE INVENTION

Against all expectations, the inventors have discovered that the cobalt catalysts described above could advantageously be used in the presence of water, alcohol or silanol.

The present invention therefore relates to a process for hydrosilylation of an unsaturated compound (A) comprising at least one function chosen from an alkene function and an alkyne function, with a compound (B) comprising at least one hydrosilyl function, said process comprising the step consisting in bringing into contact said unsaturated compound (A), said compound (B), a cobalt compound (C) of formula (1):

[Co(N(SiR₃)₂)ₓ]_{y} (1)

wherein:
the R symbols, which may be identical or different, represent a hydrogen atom or a hydrocarbon radical having from 1 to 12 carbon atoms,
x=1, 2 or 3, and
y=1 or 2;

a compound (D) of formula (2) below:

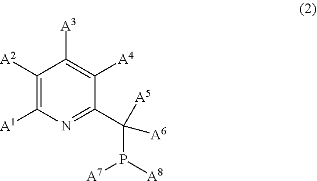

wherein:
A¹, A², A³ and A⁴ are chosen, independently of one another, from a hydrogen atom, alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms, halogens and alkoxy groups of formula OA⁹ where A⁹ is an alkyl group having from 1 to 8 carbon atoms,
A⁵ and A⁶ are chosen, independently of one another, from a hydrogen atom, alkyl groups having from 1 to 8 carbon atoms, cycloalkyl groups having from 6 to 12 carbon atoms, aryl groups having from 6 to 12 carbon atoms and arylalkyl groups having from 7 to 24 carbon atoms, and
A⁷ and A⁸ are chosen, independently of one another, from alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms and alkoxy groups of formula OA¹⁰ where A¹⁰ is an alkyl group having from 1 to 8 carbon atoms,
   and a compound (E) of formula (3) below:

R′—OH (3)

wherein R′ represents a hydrogen atom or else R′ is selected from the group consisting of alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms and silyl groups of formula Si (A¹¹)₃ where each All is chosen, independently from one another, from alkyl groups having from 1 to 8 carbon atoms.

Furthermore, the present invention also relates to a composition comprising at least one unsaturated compound (A) comprising at least one function chosen from an alkene function and an alkyne function, at least one compound (B) comprising at least one hydrosilyl function, a cobalt compound (C) of formula (1):

[Co(N(SiR₃)₂)ₓ]_{y} (1)

wherein:
the R symbols, which may be identical or different, represent a hydrogen atom or a hydrocarbon radical having from 1 to 12 carbon atoms,
x=1, 2 or 3, and
y=1 or 2;
   a compound (D) of formula (2) below:

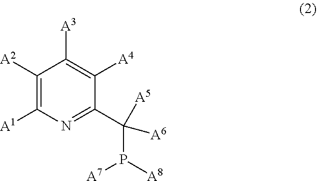

wherein:
A¹, A², A³ and A⁴ are chosen, independently of one another, from a hydrogen atom, alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms, halogens and alkoxy groups of formula OA⁹ where A⁹ is an alkyl group having from 1 to 8 carbon atoms,
A⁵ and A⁶ are chosen, independently of one another, from a hydrogen atom, alkyl groups having from 1 to 8 carbon atoms, cycloalkyl groups having from 6 to 12 carbon atoms, aryl groups having from 6 to 12 carbon atoms and arylalkyl groups having from 7 to 24 carbon atoms, and
A⁷ and A⁸ are chosen, independently of one another, from alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms and alkoxy groups of formula OA¹⁰ where A¹⁰ is an alkyl group having from 1 to 8 carbon atoms,
   and a compound (E) of formula (3) below:

R′—OH (3)

wherein R′ represents a hydrogen atom or else R′ is selected from the group consisting of alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms and silyl groups of formula Si (A¹¹)₃ where each A¹¹ is chosen, independently from one another, from alkyl groups having from 1 to 8 carbon atoms.

### DETAILED DESCRIPTION OF THE INVENTION

In the present text, the symbol “ [symbol] ” represents a covalent coordination bond due to the presence in the ligand of a free electron pair.

In the present text, according to the standard notations of the technical field, the symbol “N” represents a nitrogen atom, the symbol “Co” represents a cobalt atom, the symbol “H” represents a hydrogen atom and the symbol “P” represents a phosphorus atom.

Unless otherwise indicated, all the viscosities of the silicone oils with which the present account is concerned correspond to a “Newtonian” dynamic viscosity quantity at 25° C., i.e. the dynamic viscosity that is measured, in a manner known per se, with a Brookfield viscometer at a shear rate gradient that is low enough for the viscosity measured to be independent of the rate gradient.

Although not denoted, the possible tautomeric forms of the compounds described in the present account are included within the scope of the present invention.

In the present invention, an alkyl group may be linear or branched. An alkyl group preferably comprises between 1 and 30 carbon atoms, more preferentially between 1 and 12 carbon atoms, even more preferentially between 1 and 6 carbon atoms. An alkyl group may for example be chosen from the following groups: methyl, ethyl, n-propyl, isopropyl, n-butyl, isobutyl, s-butyl, t-butyl, n-pentyl, n-hexyl, n-heptyl, n-octyl, n-nonyl, n-decyl, n-undecyl and n-dodecyl.

In the present invention, a cycloalkyl group may be monocyclic or polycyclic, preferably monocyclic or bicyclic. A cycloalkyl group preferably comprises between 3 and 30 carbon atoms, more preferentially between 3 and 8 carbon atoms. A cycloalkyl may for example be chosen from the following groups: cyclopropyl, cyclobutyl, cyclopentyl, cyclohexyl, cycloheptyl, cyclooctyl, adamantane and norborane.

In the present invention and aryl group may be monocyclic or polycyclic, preferably monocyclic, and preferably comprises between 6 and 30 carbon atoms, more preferentially between 6 and 18 carbon atoms. An aryl group may be unsubstituted or be substituted one or more times by an alkyl group. The aryl group may be chosen from phenyl, naphthyl, anthracenyl, phenanthryl, mesityl, tolyl, xylyl, diisopropylphenyl and triisopropylphenyl groups.

In the present invention, an arylalkyl group preferably comprises between 6 and 30 carbon atoms, more preferentially between 7 and 20 carbon atoms. An arylalkyl group may for example be chosen from the following groups: benzyl, phenylethyl, phenylpropyl, naphthylmethyl, naphthylethyl and naphthylpropyl.

In the present invention, the halogen atom may for example be selected from the group consisting of fluorine, bromine, chlorine and iodine, fluorine being preferred. A fluorine-substituted alkyl group may for example be trifluoropropyl.

The present invention relates to a novel process for hydrosilylation between an unsaturated compound (A) and a compound (B) comprising at least one hydrosilyl function catalysed by a cobalt compound (C) in the presence of a compound (D) and of a compound (E) as described below.

The hydrosilylation reaction may be accompanied by a dehydrogenative silylation reaction. The cobalt compound (C) in the presence of a compound (D) and of a compound (E) as described below may advantageously be used also as a catalyst for the dehydrogenative silylation reactions between an unsaturated compound (A) comprising at least one function chosen from an alkene function and an alkyne function, and a compound (B) comprising at least one hydrosilyl function. In the present text, and unless indicated otherwise, any comment or account concerning the hydrosilylation reaction applies to the dehydrogenative silylation reaction.

The cobalt compound (C) is represented by the formula (1):

[Co(N(SiR₃)₂)ₓ]_{y} (1)

wherein:
the R symbols, which may be identical or different, represent a hydrogen atom or a hydrocarbon radical having from 1 to 12 carbon atoms,
x=1, 2 or 3, and
y=1 or 2.

Preferably, the R symbols, which may be identical or different, are selected from the group consisting of a hydrogen atom, alkyl groups having from 1 to 8 carbon atoms, cycloalkyl groups having from 3 to 8 carbon atoms, aryl groups having from 6 to 12 carbon atoms and arylalkyl groups having 7 to 24 carbon atoms. More preferably, the R symbols, which may be identical or different, are selected from the group consisting of methyl, ethyl, propyl, xylyl, tolyl and phenyl groups. Even more preferably, the R groups are methyls.

In this formula (1), the cobalt may be in the +I, +II or +III oxidation state.

According to a preferred embodiment, x=2. The cobalt compound (C) then has the formula [Co(N(SiR₃)₂)₂]_{y}, R and y being as defined above. The cobalt is then in the +II oxidation state.

According to a very preferred embodiment, the cobalt compound (C) is represented by the following formula:

[Co(N(Si(CH₃)₃)₂)₂]_{y}

wherein y is equal to 1 or 2.

The cobalt compound (C) may be obtained commercially or prepared according to any method known to those skilled in the art or described in the literature. According to one embodiment, the cobalt compound (C) [Co(N(Si(CH₃)₃)₂)₂]_{y} may be prepared by reacting a cobalt halide, for example cobalt chloride CoCl₂, with lithium bis (trimethylsilyl) amide LiN(SiMe₃)₂. The synthesis may be carried out prior to the hydrosilylation reaction, or else the cobalt compound (C) may be synthesized in situ in the presence of the unsaturated compound (A).

The molar concentration of cobalt element provided by the cobalt compound (C) may be from 0.01 mol % to 15 mol %, more preferentially from 0.05 mol % to 10 mol %, even more preferentially from 0.1 mol % to 8 mol %, relative to the total number of moles of unsaturations borne by unsaturated compound (A). According to another variant, the amount of cobalt used in the process according to the invention is between 10 ppm and 3000 ppm, more preferentially between 20 ppm 2000 ppm, and even more preferentially between 20 ppm and 1000 ppm, by weight relative to the total weight of the compounds (A), (B), (C), (D) and (E), without taking into account the optional presence of solvent. According to a preferred variant, in the process according to the invention, compounds based on platinum, palladium, ruthenium or rhodium are not used. The amount of compounds based on platinum, palladium, ruthenium or rhodium in the reaction medium is, for example, less than 0.1% by weight relative to the weight of the cobalt compound (C), preferably less than 0.01% by weight, and more preferentially less than 0.001% by weight.

The compounds (D) according to the present invention is represented by formula (2) below:

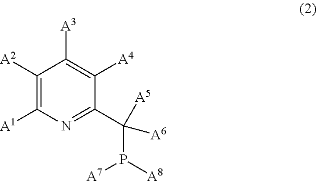

wherein:
A¹, A², A³ and A⁴ are chosen, independently of one another, from a hydrogen atom, alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms, halogens and alkoxy groups of formula OA⁹ where A⁹ is an alkyl group having from 1 to 8 carbon atoms,
A⁵ and A⁶ are chosen, independently of one another, from a hydrogen atom, alkyl groups having from 1 to 8 carbon atoms, cycloalkyl groups having from 6 to 12 carbon atoms, aryl groups having from 6 to 12 carbon atoms and arylalkyl groups having from 7 to 24 carbon atoms, and
A⁷ and A⁸ are chosen, independently of one another, from alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms and alkoxy groups of formula OA¹⁰ where A¹⁰ is an alkyl group having from 1 to 8 carbon atoms.

Preferably, in formula (2) above:
A^{1,} A^{2,} A³ and A⁴ are hydrogen atoms,
A⁵ and A⁶ are hydrogen atoms,
A⁷ and A⁸ are chosen from alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms and alkoxy groups of formula OA¹⁰ where A¹⁰ is an alkyl group having from 1 to 8 carbon atoms; and preferably A⁷ and A⁸ are chosen from t-butyl, isopropyl, methyl, ethyl, phenyl and cyclohexyl groups.

Even more preferentially, compound (D) is chosen from the compounds of formulae (4) to (9) below:

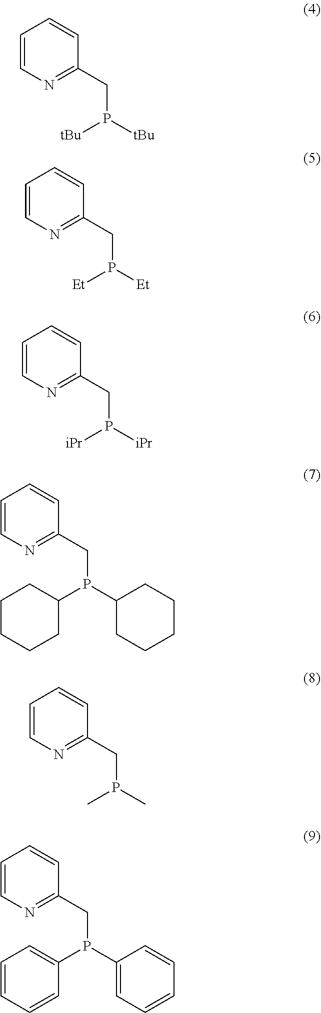

Without wishing to be bound by any one theory, compound (C) and compound (D) may react, partly or completely, to form complex. Compound (D) may then act as a ligand which can coordinate the cobalt via a free electron pair borne by the nitrogen atom or by the phosphorus atom or by both. Thus, it is possible to obtain a cobalt complex (C′) represented by formula (10) below:

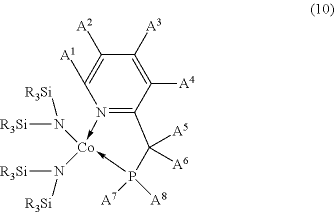

wherein R, A¹, A², A³, A⁴, A⁵, A⁶, A⁷ and A⁸ have the meanings described above.

The complex (C′) may advantageously catalyse the hydrosilylation reaction between an unsaturated compound (A) and a compound (B) comprising at least one hydrosilyl function.

According to a first embodiment, the compounds (C) and (D) may be mixed prior to the hydrosilylation reaction, and the complex (C′) may be optionally separated and purified before being used in the hydrosilylation reaction between compound (A) and compound (B).

According to a second embodiment, compound (D) may be introduced into the reaction medium with the reactants (A) and (B) and compound (C). Complexing is then possible in situ, during the hydrosilylation reaction.

During the implementation of the hydrosilylation process according to the present invention, the molar ratio between compound (D) and the cobalt element provided by compound (C) may be between 0.5 and 4, preferably between 0.8 and 3.5 and even more preferentially between 1.5 and 3.

The hydrosilylation process according to the present invention is carried out in the presence of a compound (E) as described hereinbelow of formula (3) below:

R′—OH (3)

wherein R′ represents a hydrogen atom or else R′ is selected from the group consisting of alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms and silyl groups of formula Si(A¹¹)₃ where each All is chosen, independently from one another, from alkyl groups having from 1 to 8 carbon atoms.

According to a first embodiment, R′ represents a hydrogen atom. Compound (E) is then water.

Quite surprisingly, it has been demonstrated that the hydrosilylation reaction with the cobalt catalysts described above could be carried out in the presence of water. The addition of a controlled amount of water makes it possible even to achieve better performance in terms of degree of conversion and selectivity of the reaction.

Furthermore, it was found that the water could be replaced by alcohols or silanols. According to a second embodiment, R′ represents a group chosen from alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms and silyl groups of formula Si (A¹¹); where each All is chosen, independently from one another, from alkyl groups having from 1 to 8 carbon atoms. Preferably, R′ may be selected from the group consisting of methyl, ethyl, isopropyl, t-butyl, phenyl, benzyl, trimethylsilyl, triethylsilyl, triisopropylsilyl and tri-t-butyl-silyl.

During the hydrosilylation reaction according to the present invention, compound (E) is present in a (compound (E))/(Co element provided by the cobalt compound (C)) molar ratio preferably between 0.1 and 500, more preferentially between 0.5 and 100. This ratio may be adjusted depending on the nature of compounds (A) and (B).

According to first embodiment, the unsaturated compound (A) is not an organopolysiloxane. The unsaturated compound (A) is preferably chosen from hydrocarbon compounds comprising from 2 to 40 carbon atoms, more preferentially from 2 to 12 carbon atoms, comprising one or more alkenes or alkyne unsaturations that are not part of an aromatic ring, optionally substituted one or more times by a halogen atom, and wherein one or more carbon atoms may optionally be substituted by a heteroatom, typically an oxygen atom, a nitrogen atom or a silicon atom. According to this first embodiment, compound (E) is preferably present in a (compound (E))/(Co element provided by the cobalt compound (C)) molar ratio of between 0.1 and 100, preferably between 0.1 and 50, even more preferably between 0.5 and 15.

According to a second embodiment, the unsaturated compound (A) may be an organopolysiloxane compound comprising one or more alkenes functions, preferably at least two alkene functions. According to this embodiment, compound (E) is preferably present in a (compound (E))/(Co element provided by the cobalt compound (C)) molar ratio of between 0.5 and 300, preferably between 5 and 100.

The present invention also relates to a composition comprising at least one unsaturated compound (A) comprising at least one function chosen from an alkene function and an alkyne function, at least one compound (B) comprising at least one hydrosilyl function, a cobalt compound (C) of formula (1):

[Co(N(SiR₃)₂)ₓ]_{y} (1)

wherein:
the R symbols, which may be identical or different, represent a hydrogen atom or a hydrocarbon radical having from 1 to 12 carbon atoms,
x=1, 2 or 3, and
y=1 or 2;
   a compound (D) of formula (2) below:

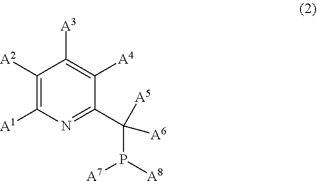

wherein:
A¹, A², A³ and A⁴ are chosen, independently of one another, from a hydrogen atom, alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms, halogens and alkoxy groups of formula OA⁹ where A⁹ is an alkyl group having from 1 to 8 carbon atoms,
A⁵ and A⁶ are chosen, independently of one another, from a hydrogen atom, alkyl groups having from 1 to 8 carbon atoms, cycloalkyl groups having from 6 to 12 carbon atoms, aryl groups having from 6 to 12 carbon atoms and arylalkyl groups having from 7 to 24 carbon atoms, and
A⁷ and A⁸ are chosen, independently of one another, from alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms and alkoxy groups of formula OA¹⁰ where A¹⁰ is an alkyl group having from 1 to 8 carbon atoms,
   and a compound (E) of formula (3) below:

R′—OH (3)

wherein R′ represents a hydrogen atom or else R′ is selected from the group consisting of alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms and silyl groups of formula Si(A¹¹)₃ where each All is chosen, independently from one another, from alkyl groups having from 1 to 8 carbon atoms.

The unsaturated compound (A) used in the hydrosilylation process according to the invention is a chemical compound comprising at least one alkene or alkyne unsaturation that is not part of an aromatic ring. The unsaturated compound (A) comprises at least one function chosen from an alkene function and an alkyne function, preferably at least one function chosen from an alkene function. It may be chosen from those known to a person skilled in the art and which do not contain a reactive chemical function that may interfere with, or even prevent, the hydrosilylation reaction.

According to one embodiment, the unsaturated compound (A) comprises one or more alkene functions and from 2 to 40 carbon atoms. According to another embodiment, the unsaturated compound (A) comprises one or more alkyne functions and from 2 to 40 carbon atoms. Preferably, the unsaturated compound (A) may be chosen from hydrocarbon compounds comprising from 2 to 40 carbon atoms, more preferentially from 2 to 12 carbon atoms, comprising one or more alkene or alkyne unsaturations that are not part of an aromatic ring, optionally substituted one or more times by a halogen atom, and wherein one or more carbon atoms may optionally be substituted by a heteroatom, typically an oxygen atom, a nitrogen atom or a silicon atom.

The unsaturated compound (A) may, preferably, be selected from the group consisting of acetylene, acrylates and methacrylates of C₁ to C₄ alkyls, acrylic or methacrylic acid, alkenes, preferably octene and more preferentially 1-octene, allyl alcohol, allylamine, allyl glycidyl ether, N-allyl-piperidine, sterically hindered N-allyl-piperidine derivatives, styrenes, preferentially a-methylstyrene, 1, 2-epoxy-4-vinylcyclohexane, chlorinated alkenes, preferably allyl chloride, and fluorinated alkenes, preferably 4, 4, 5, 5, 6, 6, 7, 7, 7-nonafluoro-1-heptene.

The unsaturated compound (A) may be a disiloxane, such as vinylpentamethyldisiloxane and divinyltetramethyldisiloxane.

The unsaturated compound (A) may be chosen from compounds comprising several alkene functions, preferably two or three alkene functions, and particularly preferably, compound (A) is chosen from the following compounds:

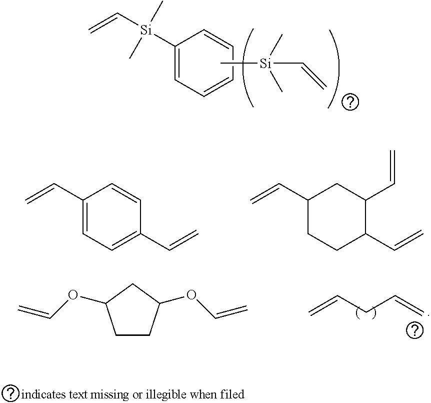

According to one particular preferred embodiment, the unsaturated compound (A) may be an organopolysiloxane compound comprising one or more alkene functions, preferably at least two alkene functions. The alkene hydrosilylation reaction is one of the key reactions in silicone chemistry. It enables not only the crosslinking between organopolysiloxanes with SiH functions and organopolysiloxanes with alkenyl functions to form networks and provide mechanical properties to the materials, but also the functionalization of the organopolysiloxanes with SiH functions in order to modify the physical and chemical properties thereof. Said organopolysiloxane compound may in particular be formed of:
at least two siloxyl units of the following formula: ViₐU_{b}SiO_{(4-a-b)/2}
   wherein:
   Vi is a C₂-C₆ alkenyl group, preferably a vinyl group,
   U is a monovalent hydrocarbon group having from 1 to 12 carbon atoms, preferably chosen from alkyl groups having from 1 to 8 carbon atoms, such as methyl, ethyl or propyl groups, cycloalkyl groups having from 3 to 8 carbon atoms and aryl groups having from 6 to 12 carbon atoms, and
   a=1, 2 or 3, preferably a=1 or 2; b=0, 1 or 2; and the sum
   a+b=1, 2 or 3; and
optionally units of the following formula: U_{c}SiO_{(4-c)/2}
   wherein U has the same meaning as above and c=0, 1, 2 or 3.

It is understood in the above formulae that, if several U groups are present, they may be identical to or different from one another.

Compounds comprising one or more alkene functions may have a linear structure, essentially consisting of “D” and “D^{Vi}” siloxyl units selected from the group consisting of Vi₂SiO_{2/2}, ViUSiO_{2/2} and U₂SiO_{2/2} siloxyl units and of terminal “M” and “M^{Vi}” siloxyl units selected from the group consisting of ViU₂SiO_{1/2}, Vi₂USiO_{1/2} and U₃SiO_{1/2} siloxyl units. The symbols Vi and U are as described above.

As examples of terminal “M” and “M^{Vi}” siloxyl units, mention may be made of trimethylsiloxy, dimethylphenylsiloxy, dimethylvinylsiloxy or dimethylhexenylsiloxy groups.

As examples of “D” and “D^{Vi}” siloxyl units, mention may be made of dimethylsiloxy, methylphenylsiloxy, methylvinylsiloxy, methylbutenylsiloxy, methylhexenylsiloxy, methyldecenylsiloxy or methyldecadienylsiloxy groups.

Examples of linear organopolysiloxanes which may be organopolysiloxane compounds comprising one more alkene functions according to the invention are:
a dimethylvinylsilyl-terminated poly (dimethylsiloxane); a dimethylvinylsilyl-terminated poly (dimethylsiloxane-co-methylphenylsiloxane);
a dimethylvinylsilyl-terminated poly (dimethylsiloxane-co-methylvinylsiloxane);
a trimethylsilyl-terminated poly (dimethylsiloxane-co-methylvinylsiloxane); and
a cyclic poly (methylvinylsiloxane).

In the most recommended form, the organopolysiloxane compound comprising one or more alkene functions contains terminal dimethylvinylsilyl units. Even more preferentially, the organopolysiloxane compound comprising one or more alkene functions is a dimethylvinylsilyl-terminated poly (dimethylsiloxane).

A silicone oil generally has a viscosity of between 1 mPa·s and 2 000 000 mPa·s. Preferably, said organopolysiloxane compounds comprising one or more alkene functions are silicone oils having a dynamic viscosity of between 20 mPa·s and 100 000 mPa·s, preferably between 20 mPa·s and 80 000 mPa·s at 25° C., and more preferentially between 100 mPa·s and 50 000 mPa·s.

Optionally, the organopolysiloxane compounds comprising one or more alkene functions may additionally contain “T” (USiO_{3/2}) siloxyl units and/or “Q” (SiO_{4/2}) siloxyl units. The U symbols are as described above. The organopolysiloxane compounds comprising one or more alkene functions then have a branched structure.

Examples of branched organopolysiloxanes, also referred to as resins, which may be organopolysiloxane compounds comprising one or more alkene functions according to the invention are:
MD^{Vi}Q, where the vinyl groups are included in the D units,
MD^{Vi}TQ, where the vinyl groups are included in the D units,
MM^{Vi}Q, where the vinyl groups are included in a portion of the M units,
MM^{Vi}TQ, where the vinyl groups are included in a portion of the M units,
MM^{Vi}DD^{Vi}Q, where the vinyl groups are included in a portion of the M and D units,
an mixtures thereof;
   with M^{Vi}=siloxyl unit of formula (U)₂ (vinyl) SiO_{1/2}, D^{Vi}=siloxyl unit of formula (U) (vinyl) SiO_{2/2}, T=siloxyl unit of formula (U) SiO_{3/2}, Q=siloxyl unit of formula SiO_{4/2}, M=siloxyl unit of formula (U)₃SiO_{1/2}, and D=siloxyl unit of formula (U)₂SiO_{2/2}, being as described above.

Preferably, the organopolysiloxane compound comprising one or more alkene functions has a weight content of alkenyl units of between 0.001% and 30%, preferably between 0.01% and 10%, preferably between 0.02 and 5%.

The unsaturated compound (A) reacts according to the present invention with a compound (B) comprising at least one hydrosilyl function.

According to one embodiment, the compound (B) comprising at least one hydrosilyl function is a silane or polysilane compound comprising at least one hydrogen atom bonded to a silicon atom. A “silane” compound is understood in the present invention to mean chemical compounds comprising a silicon atom bonded to four hydrogen atoms or to organic substituents. A “polysilane” compound is understood in the present invention to mean chemical compounds having at least one =Si-Si=unit. Among the silane compounds, the compound (B) comprising at least one hydrosilyl function may be phenylsilane or a mono-, di-or tri-alkylsilane, for example triethylsilane.

According to another embodiment, the compound (B) comprising at least one hydrosilyl function is a organopolysiloxane compound comprising at least one hydrogen atom bonded to a silicon atom, also known as organohydropolysiloxane. Said organohydropolysiloxane may advantageously be an organopolysiloxane formed of:
at least two siloxyl units of the following formula: H_{d}UₑSiO_{(4-d-e)/2}
   wherein:
   U is a monovalent hydrocarbon group having from 1 to 12 carbon atoms, preferably chosen from alkyl groups having from 1 to 8 carbon atoms, such as methyl, ethyl or propyl groups, cycloalkyl groups having from 3 to 8 carbon atoms and aryl groups having from 6 to 12 carbon atoms, and d=1, 2 or 3, preferably d=1 or 2; e=0, 1 or 2; and d+e=1, 2 or 3; and
optionally other units of the following formula: U_{f}SiO_{(4-f)/2}
   wherein U has the same meaning as above, and f =0, 1, 2, or 3.

It is understood in the above formulae that, if several U groups are present, they may be identical to or different from one another. Preferentially U may represent a monovalent radical selected from the group consisting of alkyl groups having 1 to 8 carbon atoms, optionally substituted by at least one halogen atom such as chlorine or fluorine, cycloalkyl groups having from 3 to 8 carbon atoms and aryl groups having from 6 to 12 carbon atoms. U may advantageously be selected from the group consisting of methyl, ethyl, propyl, 3,3,3-trifluoropropyl, xylyl, tolyl and phenyl.

In the above formula, the symbol d is preferentially equal to 1.

The organohydropolysiloxane may have a linear, branched, or psychic structure. The degree of polymerization is preferably greater than or equal to 2. Generally, it is less than 5000.

When it is a question of linear polymers, these essentially consists of siloxyl units chosen from the units of the following formulae D: U₂SiO_{2/2} or D′: UHSiO_{2/2}, and terminal siloxyl units chosen from the units of the following formulae M: U₃SiO_{1/2} or M′: U₂HSiO_{1/2}, where U has the same meaning as above.

Examples of organohydropolysiloxanes which may be compounds (B) comprising at least one hydrosilyl function according to the invention are:
a hydrodimethylsilyl-terminated poly (dimethylsiloxane);
a trimethylsilyl-terminated poly (dimethylsiloxane-co-methylhydrosiloxane);
a hydrodimethylsilyl-terminated poly (dimethylsiloxane-co-methylhydrosiloxane);
a trimethylsilyl-terminated poly (methylhydrosiloxane); and
a cyclic poly (methylhydrosiloxane).

When the organohydropolysiloxane has a branch structure, it is preferably selected from the group consisting of silicone resins of the following formulae:
M′Q where the hydrogen atoms bonded to silicon atoms are borne by the M groups,
MM′Q where the hydrogen atoms bonded to silicon atoms are borne by a portion of the M units,
MD′Q where the hydrogen atoms bonded to silicon atoms are borne by the D groups,
MDD′Q where the hydrogen atoms bonded to silicon atoms are borne by a portion of the D groups,
MM′TQ where the hydrogen atoms bonded to silicon atoms are borne by a portion of the M units,
MM′DD′Q where the hydrogen atoms bonded to silicon atoms are borne by a portion of the M and D units,
and mixtures thereof,
   with M, M′, D and D′ as defined above, T: siloxyl unit of formula USiO_{3/2} and Q: siloxyl unit of formula SiO_{4/2} where U has the same meaning as above.

Preferably, the organohydropolysiloxane compound has a weight content of Si—H hydrosilyl functions of between 0.2% and 91%, more preferentially between 3% and 80%, and even more preferentially between 15% and 70%.

According to one particular embodiment of the present invention, it is possible for the unsaturated compound (A) and the compound (B) comprising at least one hydrosilyl function to be one and the same compound, comprising firstly at least one ketone function, one aldehyde function, one alkene function and/or one alkyne function, and secondly at least one silicon atom and at least one hydrogen atom bonded to the silicon atom. This compound may then be described as “bifunctional”, and it is capable of reacting with itself by a hydrosilylation reaction. The invention may therefore also relates to a process for hydrosilylation of a bifunctional compound with itself, said bifunctional compound comprising firstly at least one function selected from the group consisting of a ketone function, and aldehyde function, and alkene function and an alkyne function (preferably at least one alkene function and/or at least one alkyne function), and secondly at least one silicon atom and at least one hydrogen atom bonded to the silicon atom, said process being catalysed by a cobalt compound (C) in the presence of a compound (D) and a compound (E) as described above.

Examples of organopolysiloxanes which may be bifunctional compounds are:
a dimethylvinylsilyl-terminated poly (dimethylsiloxane-co-hydromethylsiloxane-co-vinylmethylsiloxane);
a dimethylhydrosilyl-terminated poly (dimethylsiloxane-co-hydromethylsiloxane-co-vinylmethylsiloxane); and
a trimethylsilyl-terminated poly (dimethylsiloxane-co-hydromethylsiloxane-co-propyl glycidyl ether methylsiloxane).

When it is question of the use of the unsaturated compound (A) and the compound (B) comprising at least one hydrosilyl function, a person skilled in the art understands that this also means the use of a bifunctional compound.

The amounts of compound (A) and compound (B) may be controlled so that the molar ratio of the hyrosilyl functions of the compounds (B) to the alkene and alkyne functions of the compounds (A) is preferably between 1:10 and 10:1, more preferably between 1:5 and 5:1, and more preferably between 1:3 and 3:1.

The hydrosilylation reaction may be carried out in a solvent or in the absence of solvent. As a variant, one of the reactants, for example the unsaturated compound (A), may act as solvent. Suitable solvents are solvents that are miscible with compound (B). The hydrosilylation reaction may be carried out at a temperature between 15° C. and 300°° C., preferentially between 20° C. and 240° C., more preferentially between 50° C. and 200°° C., more preferentially between 50°° C. and 140°° C., and even more preferentially between 50°° C. and 100° C.

According to one preferred embodiment of the invention, the compounds (A) and (B) used are chosen the from organopolysiloxanes as defined above. In this case, a three-dimensional network is formed, which leads to the curing of the composition. Crosslinking involves the gradual physical change in the medium constituting the composition. Consequently, the process according to the invention can be used to obtain elastomers, gels, foams, etc. In this case, a crosslinked silicone material is obtained. A “crosslinked silicon material” is understood to mean any silicone-based product obtained by crosslinking and/or curing of compositions comprising organopolysiloxanes having at least two unsaturated bonds and organopolysiloxanes having at least three hydrosilyl units. The crosslinked silicone material may for example be an elastomer, a gel or a foam.

Still according to this preferred embodiment of the process according to the invention, where the compounds (A) and (B) are chosen from the organopolysiloxanes as defined above, use may be made of functional additives that are customary in silicone compositions. As families of usual functional additives, mention may be made of:
fillers;
adhesion promoters;
inhibitors or retarders of the hydrosilylation reaction;
adhesion modulators;
silicone resins;
consistency-enhancing additives;
pigments; and
heat-resistant, oil-resistant or fire-resistant additives, for example metal oxides.

Other details or advantages of the invention will become more clearly apparent in light of the examples given below purely by way of indication.

### EXAMPLES

All the experiments involving air-sensitive and moisture-sensitive compounds were carried out under an inert atmosphere of dry argon and in a glove box. Before use, the solvents and the reactants used were purified and degassed, and dried and stored over a molecular sieve.

### Example 1: Synthesis of the Co[N(SiMe₃)₃]₂ Cobalt (II) Bisamide Complex (COBAM)

1.0830 g (8.34×10⁻³ mol) of cobalt chloride CoCl₂ and 2.7895 g (1.67×10⁻² mol) of lithium bis (trimethylsilyl) amide LiN (SiMe₃)₂ were weighed in a glove box in a 200 ml Schlenk tube. 100 ml of Et₂O were added to the tube immersed in an ice bath, then the suspension was stirred for 10 h at 0° C. The solution took on a dark green color and a white/gray precipitate formed. The solvent was evaporated and the complex was extracted 3 times with 30 ml of pentane. After evaporation of the pentane, a highly viscous green oil was obtained. This oil was then sublimed under high vacuum (10⁻⁷ mbar) at 80° C. leading to the formation of a brown-brick red powder. Yield=70%.

### Example 2: Synthesis of the Cobalt (II) Bisamide+Ligand Complex (COBAM+PN)

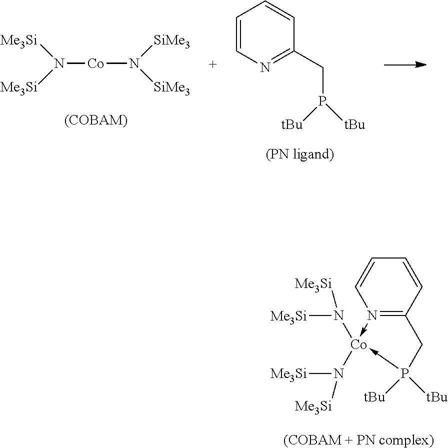

40.1 mg of 2-(di-t-butylphosphinomethyl) pyridine (hereinafter “PN ligand”) (1.69×10⁻⁴ mol) were dissolved in 3 ml of pentane. At the same time, 64.2 mg of Co[N (SiMe₃)₂]₂ (COBAM) obtained as described in example 1 (1.69×10⁻⁴ mol) were dissolved in 3 ml of pentane. The solution of PN ligand was then added to the solution of cobalt (II) bisamide. The medium was left stirring for 1 h at room temperature. The pentane was then evaporated and a light green powder was obtained with a yield of greater than 98%. The structure of the cobalt (II) bisamide+PN ligand was confirmed by NMR.

### Examples 3-10: Functionalization Tests

The desired mass of the cobalt (II) bisamide complex (COBAM) obtained as described in example 1 was weighed in a glove box, under an inert atmosphere of argon, and was introduced into dry hermetic flasks. The desired mass of PN ligand was weighed and introduced into the flasks. 0.3 g of dodecane were added and the medium was placed under stirring in order to dissolve the pre-catalyst. Next, the desired mass of unsaturated compound (A) was introduced, followed by the desired mass of compound (B). Under a stream of argon and using a micropipette, the desired volume of compound (E) was introduced. The reactive media were then placed under stirring for 5 minutes and then they were placed in the small metal barrel preheated to 75° C. (t=0).

To determine the conversions and the selectivites, the reaction medium was analysed quantitatively by gas chromatography.

For all of examples 3 to 15: the compound (B) used is 1, 1, 1, 3, 5, 5, 5-heptamethyl-3-hydrotrisiloxane (hereinafter “MD′M”). SiH/SiVi molar ratio=1. Amount of catalyst (COBAM)=0.5 mol % (molar percentage of cobalt element provided by the catalyst relative to the number of moles of vinyl radicals bonded to the silicon provided by compound (B)).

TABLE 1

| | | | | | Hydrosilylation |
|---|---|---|---|---|---|
| | | | | | selectivity |
| | Catalytic | | Compound (E) | MD′M | (vs. 1- |
| | system | Compound (A) | (E)/Co molar ratio | conversion | octene) |
| Ex. | (COBAM) | 1-octene | 0 | 40% at | 36% at |
| 3 | (no PN | | | 24 h | 24 h |
| | ligand) | | | | |
| Ex. | (COBAM) | 1-octene | water (substrates | 0% at | 0% at |
| 4 | (no PN | | not degassed and | 24 h | 24 h |
| | ligand) | | not dried | | |
| Ex. | (COBAM) + | 1-octene | 0 | 4% at | 0% at |
| 5 | PN ligand | | | 40 min | 40 min |
| | (2 eq.) | | | | |
| Ex. | (COBAM) + | 1-octene | water | 75% at | 83% at |
| 6 | PN ligand | | water/Co ratio = 1 | 40 min | 40 min |
| | (2 eq.) | | | | |
| Ex. | (COBAM) + | 1-octene | water | 42% at | 52% at |
| 7 | PN ligand | | water/Co ratio = 10 | 40 min | 40 min |
| | (2 eq.) | | | | |
| Ex. | (COBAM)+ | 1-octene | water | 15% at | 22% at |
| 8 | PN ligand | | water/Co ratio = 60 | 40 min | 40 min |
| | (2 eq.) | | | | |
| Ex. | (COBAM) + | vinyl- | 0 | 13% at | 65% at |
| 9 | PN ligand | pentamethyl- | | 40 min | 40 min |
| | (2 eq.) | disiloxane | | | |
| Ex. | (COBAM) + | vinyl- | water | 85% at | 87% at |
| 10 | PN ligand | pentamethyl- | water/Co ratio = 1 | 40 min | 40 min |
| | (2 eq.) | disiloxane | | | |
| Ex. | (COBAM) + | 1-octene | benzyl alcohol | 50% at | 60% at |
| 11 | PN ligand | | (E)/Co ratio = 1 | 40 min | 40 min |
| | (2 eq.) | | | | |
| Ex. | (COBAM) + | 1-octene | ethanol (E)/Co | 47% at | 50% at |
| 12 | PN ligand | | ratio = 1 | 40 min | 40 min |
| | (2 eq.) | | | | |
| Ex. | (COBAM) + | 1-octene | isopropanol (E)/Co | 59% at | 64% at |
| 13 | PN ligand | | ratio = 1 | 40 min | 40 min |
| | (2 eq.) | | | | |
| Ex. | (COBAM) + | 1-octene | trimethylsilanol | 71% at | 77% at |
| 14 | PN ligand | | (E)/Co ratio = 1 | 40 min | 40 min |
| | (2 eq.) | | | | |
| Ex. | (COBAM) + | 1-octene | triisopropylsilanol | 89% at | 89% at |
| 15 | PN ligand | | (E)/Co ratio = 1 | 40 min | 40 min |
| | (2 eq.) | | | | |

### Examples 16-26: Crosslinking Tests

The desired mass of the cobalt (II) bisamide complex (COBAM) was weighed in a glove box, under an inert atmosphere of argon, and was introduced into dry hermetic flasks. The desired mass of PN ligand was weighed and introduced into the flasks. The organopolysiloxanes were then introduced in the following order: firstly, the unsaturated organopolysiloxane (A) was injected. Then the medium was placed under stirring in order to dissolve the complex (COBAM). Lastly, the hydrogenated organopolysiloxane (B) was added. Under a stream of argon and using a micropipette, the desired volume of compound (E) was introduced. The reactive media were then placed under stirring for 5 minutes and then placed in the small metal barrel preheated to 90° C. (t=0).

The gel time for the crosslinking experiments is measured qualitatively by a stirring stop time (SST). This SST is linked to an increase in the viscosity which is so great that the medium can no longer be stirred (equivalent to a viscosity of approximately 1000 mPa·s).

For all of examples 16 to 26: SiH/SiVi molar ratio=2. Amount of catalyst (COBAM)=1 mol % (molar percentage of cobalt element provided by the catalyst relative to the number of moles of vinyl radicals bonded to the silicon provided by compound (B)).

A1: dimethylvinylsilyl-terminated poly (dimethylsiloxane), viscosity at 25° C.: around 100 mPa·s, content of vinyl groups: around 1.08% by weight.

B1: trimethylsilyl-terminated poly (methylhydrosiloxane), viscosity at 25° C.: around 20 mPa·s, content of SiH groups: around 44.5% by weight.

B2: hydrodimethylsilyl-terminated and trimethylsilyl-terminated poly (dimethylsiloxane-co-methylhydrosiloxane), viscosity at 25° C.: around 20 mPa·s, content of SiH groups: around 20% by weight.

TABLE 2

| | Catalytic | Compound | Compound | Compound (E) | | |
|---|---|---|---|---|---|---|
| | system | (A) | (B) | (E)/Co molar ratio | SST | |
| Ex. | (COBAM) | A1 | B1 | 0 | 38 | min |
| 16 | (no PN | | | | | |
| | ligand) | | | | | |
| Ex. | (COBAM) | A1 | B1 | water | Between | |
| 17 | (no PN | | | water/Co ratio = 60 | 9 h and | |
| | ligand) | | | | 20 h | |
| Ex. | (COBAM) + | A1 | B1 | 0 | 37 | min |
| 18 | PN ligand | | | | | |
| | (2 eq.) | | | | | |
| Ex. | (COBAM) + | A1 | B1 | water | 15 | min |
| 19 | PN ligand | | | water/Co ratio = 0.5 | | |
| | (2 eq.) | | | | | |
| Ex. | (COBAM) + | A1 | B1 | water | 8 | min |
| 20 | PN ligand | | | water/Co ratio = 1 | | |
| | (2 eq.) | | | | | |
| Ex. | (COBAM) + | A1 | B1 | water | 2 | min |
| 21 | PN ligand | | | water/Co ratio = 10 | | |
| | (2 eq.) | | | | | |
| Ex. | (COBAM) + | A1 | B1 | water | 1.5 | min |
| 22 | PN ligand | | | water/Co ratio = 40 | | |
| | (2 eq.) | | | | | |
| Ex. | (COBAM) + | A1 | B1 | water | 1 | min |
| 23 | PN ligand | | | water/Co ratio = 60 | | |
| | (2 eq.) | | | | | |
| Ex. | (COBAM) + | A1 | B1 | Water | 4.5 | min |
| 24 | PN ligand | | | water/Co ratio = 200 | | |
| | (2 eq.) | | | | | |
| Ex. | (COBAM) + | A1 | B2 | 0 | 15 | min |
| 25 | PN ligand | | | | | |
| | (2 eq.) | | | | | |
| Ex. | (COBAM) + | A1 | B2 | Water | 8 | min |
| 26 | PN ligand | | | water/Co ratio = 1 | | |
| | (2 eq.) | | | | | |

1. A process for hydrosilylation of an unsaturated compound A comprising at least one function chosen from an alkene function and an alkyne function, with a compound B comprising at least one hydrosilyl function, said process comprising the step consisting in bringing into contact said unsaturated compound A, said compound B, a cobalt compound C of formula (1):
[Co(N(SiR₃)₂)ₓ]_{y} (1)
wherein:
the R symbols, which may be identical or different, represent a hydrogen atom or a hydrocarbon radical having from 1 to 12 carbon atoms,
x=1, 2 or 3, and
y=1 or 2;
a compound D of formula (2) below: 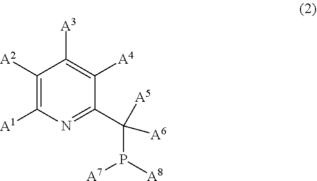
wherein:
A¹, A², A³ and A⁴ are chosen, independently of one another, from a hydrogen atom, alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms, halogens and alkoxy groups of formula OA⁹ where A⁹ is an alkyl group having from 1 to 8 carbon atoms,
A⁵ and A⁶ are chosen, independently of one another, from a hydrogen atom, alkyl groups having from 1 to 8 carbon atoms, cycloalkyl groups having from 6 to 12 carbon atoms, aryl groups having from 6 to 12 carbon atoms and arylalkyl groups having from 7 to 24 carbon atoms, and
A⁷ and A⁸ are chosen, independently of one another, from alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms and alkoxy groups of formula OA¹⁰ where A¹⁰ is an alkyl group having from 1 to 8 carbon atoms, and a compound E of formula (3) below:
R′—OH (3)
wherein R′ represents a hydrogen atom or else R′ is selected from the group consisting of alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms and silyl groups of formula Si(A¹¹)₃ where each A¹¹ is chosen, independently from one another, from alkyl groups having from 1 to 8 carbon atoms.

2. The process as claimed in claim 1, wherein the compound E is water.

3. The process as claimed in claim 1, wherein the compound E is an alcohol or a silanol of formula (3) below:
R′—OH (3)
wherein R′ is selected from the group consisting of alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms and silyl groups of formula Si (A¹¹)₃ where each A¹¹ is chosen, independently from one another, from alkyl groups having from 1 to 8 carbon atoms.

4. The process as claimed in claim 1, wherein the compound E is present in a (compound E)/(Co element provided by the cobalt compound C) molar ratio of between 0.1 and 500, optionally between 0.5 and 100.

5. The process as claimed in claim 1, wherein the cobalt compound C is represented by the following formula:
[Co(N(Si(CH₃)₃)₂)₂]_{y}
wherein y is equal to 1 or 2.

6. The process as claimed in claim 1, wherein the compound D is represented by the formula (2) below: 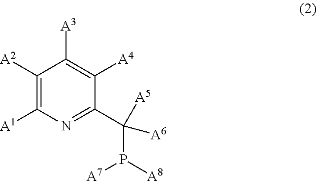
wherein:
A¹, A², A³ and A⁴ are hydrogen atoms,
A⁵ and A⁶ are hydrogen atoms,
A⁷ and A⁸ are chosen from alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms and alkoxy groups of formula OA¹⁰ where A¹⁰ is an alkyl group having from 1 to 8 carbon atoms; and optionally A⁷ and A⁸ are chosen from t-butyl, isopropyl, methyl, ethyl, phenyl and cyclohexyl groups.

7. The process as claimed in claim 1, wherein the unsaturated compound A is not an organopolysiloxane and is chosen from hydrocarbon compounds comprising from 2 to 40 carbon atoms, optionally from 2 to 12 carbon atoms, comprising one or more alkenes or alkyne unsaturations that are not part of an aromatic ring, optionally substituted one or more times by a halogen atom, and wherein one or more carbon atoms may optionally be substituted by a heteroatom, optionally an oxygen atom, a nitrogen atom or a silicon atom.

8. The process as claimed in claim 7, wherein the compound E is present in a (compound E)/(Co element provided by the cobalt compound C) molar ratio of between 0.1 and 100, optionally between 0.1 and 50, optionally between 0.5 and 15.

9. The process as claimed in claim 1, wherein the unsaturated compound A is an organopolysiloxane compound comprising one or more alkenes functions, optionally at least two alkene functions.

10. The process as claimed in claim 9, wherein the compound E is present in a (compound E)/(Co element provided by the cobalt compound C) molar ratio of between 0.5 and 300, optionally between 5 and 100.

11. A composition comprising:
at least one unsaturated compound A comprising at least one function chosen from an alkene function and an alkyne function,
at least one compound B comprising at least one hydrosilyl function,
a cobalt compound C of formula (1):
[Co(N(SiR₃)₂)ₓ]_{y} (1)
wherein:
the R symbols, which may be identical or different, represent a hydrogen atom or a hydrocarbon radical having from 1 to 12 carbon atoms,
x=1, 2 or 3, and
y=1 or 2;
a compound D of formula (2) below: 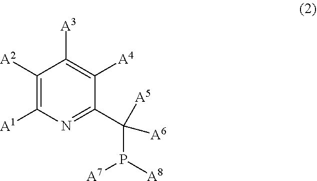
wherein:
A¹, A², A³ and A⁴ are chosen, independently of one another, from a hydrogen atom, alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms, halogens and alkoxy groups of formula OA⁹ where A⁹ is an alkyl group having from 1 to 8 carbon atoms,
A⁵ and A⁶ are chosen, independently of one another, from a hydrogen atom, alkyl groups having from 1 to 8 carbon atoms, cycloalkyl groups having from 6 to 12 carbon atoms, aryl groups having from 6 to 12 carbon atoms and arylalkyl groups having from 7 to 24 carbon atoms, and
A⁷ and A⁸ are chosen, independently of one another, from alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms and alkoxy groups of formula OA¹⁰ where A¹⁰ is an alkyl group having from 1 to 8 carbon atoms, and
a compound E of formula (3) below:
R′—OH (3)
wherein R′ represents a hydrogen atom or else R′ is selected from the group consisting of alkyl groups having from 1 to 8 carbon atoms, cycloalkyl groups having from 6 to 12 carbon atoms, aryl groups having from 6 to 12 carbon atoms, arylalkyl groups having from 7 to 24 carbon atoms and silyl groups of formula Si (A¹¹)₃ where each A¹¹ is chosen, independently from one another, from alkyl groups having from 1 to 8 carbon atoms.

12. The composition as claimed in claim 11, wherein the compound E is present in a (compound E)/(Co element provided by the cobalt compound C) molar ratio of between 0.1 and 500, optionally between 0.5 and 100.
